(19) United States
(12) Patent Application Publication
(10) Pub. No.: US 2023/0176462 A1
(43) Pub. Date: Jun. 8, 2023

(54) OPTICAL ENGINE MODULE AND PROJECTION DEVICE

(71) Applicant: Coretronic Corporation, Hsin-Chu (TW)

(72) Inventors: Chun-Lung Yen, Hsin-Chu (TW); Wen-Jui Huang, Hsin-Chu (TW); Te-Ying Tsai, Hsin-Chu (TW)

(73) Assignee: Coretronic Corporation, Hsin-Chu (TW)

(21) Appl. No.: 17/988,756

(22) Filed: Nov. 17, 2022

(30) Foreign Application Priority Data
Dec. 3, 2021 (CN) 202123015904.6

(51) Int. Cl. G03B 21/16; G03B 21/14

(52) U.S. Cl. CPC G03B 21/16; G03B 21/145

(57) ABSTRACT

An optical engine module including a housing, an optical element, a positioning member, and a heat dissipation assembly is provided. The optical element and the positioning member are arranged in the housing. The positioning member abuts and positions the optical element. The heat dissipation assembly is coupled to the positioning member. The heat dissipation assembly absorbs heat generated by the optical element through the positioning member and transmits the heat outside the housing. A projection device is also provided.

### CROSS-REFERENCE TO RELATED APPLICATION

This application claims the priority benefit of Chinese application serial No. 202123015904.6, filed on Dec. 3, 2021. The entirety of the above-mentioned patent application is hereby incorporated by reference herein and made a part of this specification.

### BACKGROUND

### Technical Field

The disclosure relates to an optical engine module and a projection device.

### Description of Related Art

A projection device is a display device used to produce large-sized images. Its imaging principle is to convert the illumination beam generated by a light source into an image beam by an optical engine module, and then project the image beam onto a screen or wall through a lens module. In the above process, the optical elements involved in beam transmission also accumulate heat, so how to provide effective heat dissipation for these optical elements becomes one of the issues of projection technology.

The existing means of heat dissipation is to design a fan inside the optical engine machine to provide cooling air flow to blow the optical elements, but the vibration generated by the rotation of the fan has an impact on the optical imaging. Another means of heat dissipation is to blow cooling air directly to the optical elements inside the housing, which can directly dissipate heat of the optical elements, but the ensuing problem is that the dust tightness inside the housing of the optical engine module is destroyed, and dust and even objects from the external environment can easily be brought in by the air flow and cause damage to the optical elements.

Since the heat dissipation methods still cause problems, it is necessary for those skilled in the art to consider how to provide a proper heat dissipation method for the projection device and its optical engine module.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an optical engine module and a projection device, in which a heat dissipation assembly absorbs heat generated by the optical element through a positioning member and transmits the heat outside the housing, thus improving a heat dissipation effect of the optical engine module and the projection device.

Other objectives and advantages of the disclosure may be further understood from the technical features disclosed in the disclosure.

In order to achieve one or part or all of the above objectives or other objectives, an embodiment of the disclosure provides an optical engine module for a projection device. The optical engine module includes a housing, an optical element, a positioning member, and a heat dissipation assembly. The optical element and the positioning member are arranged in the housing. The positioning member abuts and positions the optical element. The heat dissipation assembly is coupled to the positioning member. The heat dissipation assembly absorbs heat generated by the optical element through the positioning member and transmits the heat outside the housing.

In order to achieve one or part or all of the above objectives or other objectives, an embodiment of the disclosure provides a projection device including a light source, an optical engine module, a light valve and a lens module. The light source is configured to provide an illumination beam. The optical engine module is configured to transmit the illumination beam to the light valve. The light valve is configured to convert the illumination beam into an image beam. The lens module is configured to project the image beam. The optical engine module includes a housing, an optical element, a positioning member, and a heat dissipation assembly. The optical element and the positioning member are arranged in the housing. The positioning member abuts and positions the optical element. The heat dissipation assembly is coupled to the positioning member. The heat dissipation assembly absorbs heat generated by the optical element through the positioning member and transmits the heat outside the housing.

Based on the above, in the optical engine module and the projection device applying the optical engine module, the positioning member and the optical element are disposed in the housing, and then the heat dissipation assembly is coupled to the positioning member and absorbs the heat generated by the optical element through the positioning member, thereby transmitting the heat outside the housing. The heat dissipation means provides a heat dissipation path that transmits heat from the inside of the housing to the outside of the housing, which helps to improve the heat dissipation effect of the optical engine module and the projection device, and avoids contaminating the optical element or even causing damage to the optical element by providing cooling air flow directly to the element inside the housing.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a simple block diagram of a projection device.

FIG. 2 is an exploded diagram of a structure of an optical engine module in FIG. 1.

FIG. 3 and FIG. 4 are schematic diagrams of an optical element of the optical engine module of FIG. 2 from different perspectives respectively.

FIG. 5 to FIG. 9 are partial cross-sectional diagrams of an optical engine module according to multiple different embodiments of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

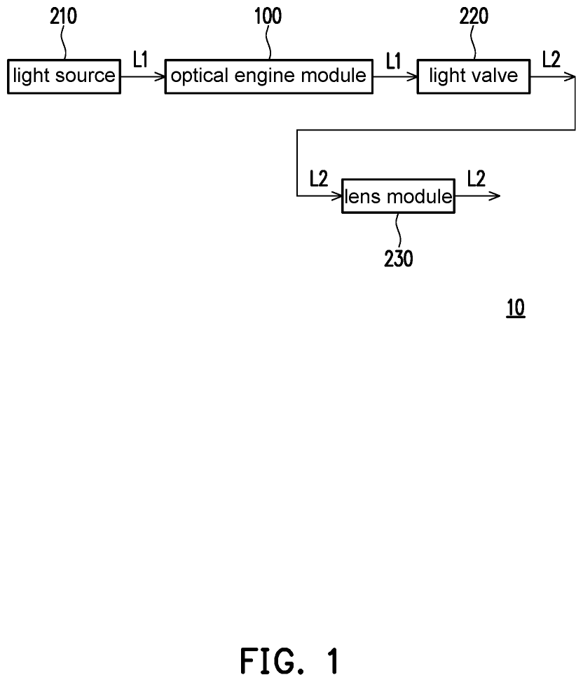

FIG. 1 is a simple block diagram of a projection device. Referring to FIG. 1, according to this embodiment, a projection device 10 includes a light source 210, an optical engine module 100, a light valve 220, and a lens module 230. The light source 210 is configured to provide an illumination beam L1, the optical engine module 100 is configured to transmit the illumination beam L1 to the light valve 220, the light valve 220 is configured to convert the illumination beam L1 into an image beam L2, and finally the lens module 230 adjusts the image beam L2 and projects the image beam L2 outside the projection device 10.

The light valve 220 is, for example, a reflective light modulator such as a liquid crystal on silicon panel (LCoS panel) or a digital micro-mirror device (DMD). According to some embodiments, the light valve 220 may also be a transparent light modulator such as a transparent liquid crystal panel, an electro-optical modulator, a magneto-optic modulator, or an acousto-optic modulator (AOM). The disclosure does not limit the type and the variety of the light valve 220. Detailed steps and implementation of a method of converting the illumination beam L1 to the image beam L2 by the light valve 220 may be adequately taught, suggested and implemented by the usual knowledge in the field, and therefore will not be repeated in the following. According to this embodiment, a number of the light valve 220 is one. The projection device 10, for example, uses a single digital micromirror device, but in other embodiments multiple digital micromirror devices may be used, and the disclosure is not limited thereto.

The lens module 230 includes, for example, a combination of one or more optical lenses with refractive power. The optical lens includes, for example, a non-planar lens such as a biconcave lens, a biconvex lens, a concave-convex lens, a convex-concave lens, a plano-convex lens, a plano-concave lens, etc., or various combinations thereof. According to an embodiment, the lens module 230 may further include a flat optical lens to project the image beam L2 from the lens module 230 to a projection target in a reflective manner. The disclosure does not limit the type and the variety of lens module 230.

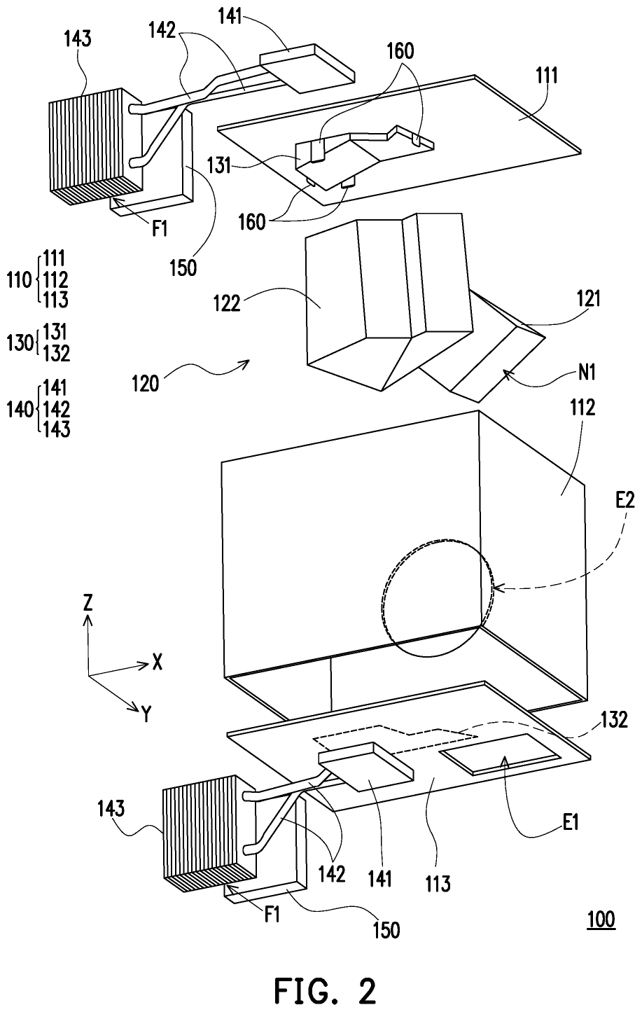

FIG. 2 is an exploded diagram of a structure of an optical engine module in FIG. 1. Coordinates X-Y-Z are also provided for component description. Referring to FIG. 2, according to this embodiment, an optical engine module 100 includes a housing 110, an optical element 120, a positioning member 130, and a heat dissipation assembly 140. The optical element 120 and the positioning member 130 are arranged in the housing 110. The positioning member 130 abuts and positions the optical element 120. The heat dissipation assembly 140 is coupled to the positioning member 130. The heat dissipation assembly 140 absorbs heat generated by the optical element 120 through the positioning member 130 and transmits the heat outside the housing 110.

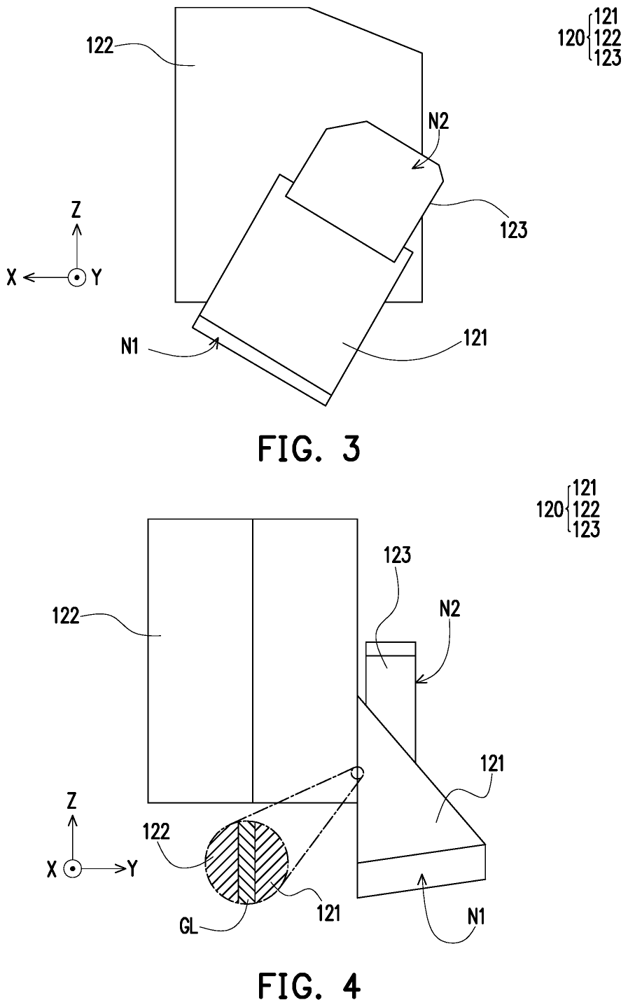

FIG. 3 and FIG. 4 are schematic diagrams of an optical element of the optical engine module of FIG. 2 from different perspectives respectively. Referring to FIG. 2 to FIG. 4 at the same time, further, as shown in FIG. 2, the housing 110 is composed of a top plate 111, a side wall 112, and a bottom plate 113. The positioning member 130 includes components 131 and 132 arranged on the top plate 111 and the bottom plate 113 respectively, and each of the components 131 and 132 forms an unitary structure with the corresponding top plate 111 and the bottom plate 113. The component 131 abuts against a top surface of the optical element 120 and the component 132 abuts against a bottom surface of the optical element 120 to position the optical element 120 in the housing 110. The optical element 120 includes at least two prisms (herein prisms 121, 122, and 123 are shown as examples). Adjacent parts of the prisms 121, 122, and 123 are attached to each other by an optical glue GL, and relative positions of the prisms 121, 122, and 123 are fixed accordingly. The illumination beam L1 (marked in FIG. 1) entering the optical engine module 100 passes through an opening E1 of the bottom plate 113, enters the optical element 120 through an incident surface N1 of the optical element 120, and is transmitted out of the optical engine module 100 from an exit surface N2 of the optical element 120 and through an opening E2 of the side wall 112 after passing through the prisms 121, 122, and 123. It should be noted that the openings E1 and E2 shown in FIG. 2 are light path channels for the illumination beam L1 to pass through, which connect to other optical components of the projection device 10 not shown, and do not mean that the internal space of the housing 110 is thus exposed to the external environment.

According to one embodiment, the light valve 220 may be disposed on a side adjacent to the prism 122. The beam L1 passes through the opening E1 of the bottom plate 113, enters the optical element 120 through the incident surface N1 of the optical element 120, is reflected through the optical element 120 to the light valve 220, and then is transmitted out of the optical module 100 through passing through the exit surface N2 of the optical element 120 and the opening E2 of the side wall 112.

Referring to FIG. 2 again, according to this embodiment, the heat dissipation assembly 140 includes a heat sink 143, a heat exchanger 141, and a heat pipe 142. The heat sink 143 is disposed outside the housing 110, and for example, includes a plurality of heat dissipating fins. The heat exchanger 141 is in thermal contact with the component 131 located inside the top plate 111 through the top plate 111 of the housing 110, and the heat pipe 142 is connected between the heat exchanger 141 and the heat sink 143. Here, the housing 110 and the positioning member 130 are made of metal or a material with better heat transfer capability, so that the heat accumulated on the optical element 120 during the operation of the projection device 10 is transmitted to the heat exchanger 141 through the component 131 of the positioning member 130 and the top plate 111 of the housing 110, and then through the heat pipe 142 to the heat sink 143. As shown in FIG. 2, outer surfaces of the top plate 111 and the bottom plate 113 of the housing 110 are both provided with the heat dissipation assembly 140, and the heat dissipation assembly 140 has the same structural features, so similarly, the heat from the optical element 120 may also be transmitted to the heat exchanger 141 through the component 132 of the positioning member 130, the bottom plate 113 of the housing 110, and to the heat sink 143 through the heat pipe 142. Furthermore, the optical engine module 100 also includes a fan 150. The fan 150 is configured to generate an air flow F1 toward the heat sink 143 to facilitate the removal of the heat absorbed by the heat sink 143.

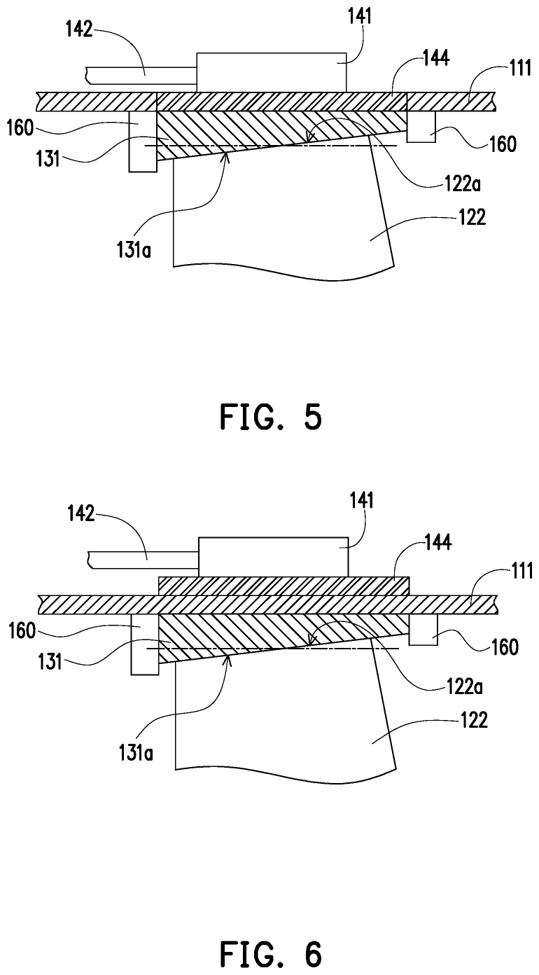

FIG. 5 to FIG. 9 are partial cross-sectional diagrams of an optical engine module according to multiple different embodiments of the disclosure. Referring to FIG. 5 and comparing with FIG. 2, the difference between FIG. 5 and FIG. 2 is that the heat dissipation assembly of FIG. 5 includes, in addition to the components of the foregoing embodiment, a thermoelectric cooler 144 disposed on the top plate 111 and located between the heat exchanger 141 and the component 131. The thermoelectric cooler 144 is configured to assist heat transmission of the positioning member 130 to accelerate the speed and total amount of heat transmission out of the housing 110. Briefly, unlike the top plate 111 of the housing 110 shown in FIG. 2, which is in thermal contact between the heat exchanger 141 and the component 131 of the positioning member 130, FIG. 5 shows the thermoelectric cooler 144 embedded in the top plate 111 of the housing 110 and absorbing heat generated by the prism 122 of the optical element 120 through the component 131 of the positioning member 130.

In addition, a structure shown in FIG. 5 is the same as in the foregoing embodiment, so that partial features of the foregoing embodiment may be further known with reference to FIG. 5, i.e., contours of the positioning member 130 and the optical element 120 at a junction are adapted to each other and are complementary. FIG. 5 shows an example of the component 131 and the prism 122. The complementary contours means that the junction of two components is based on the horizontal plane. If a surface contour of one of the component is protruding at the junction, a surface contour of the other component is concave at the junction, as a correspondence of the two components. That is to say, when one of the two components is moving, the other one is moved inevitably, thus achieving an effect of component adjustment and positioning.

In FIG. 5, for example, a surface contour 131a of the component 131 abuts a surface contour 122a of the prism 122, and considering a point chain line shown in FIG. 5 as a base plane, the left side of the prism 122 is concave and the right side is convex, so the component 131 needs to be convex on the left side and concave on the right side in order to adapt the surface contour 131a to the surface contour 122a. In this way, when the user moves the component 131 of the positioning member 130, the prism 122 is inevitably moved by a specific relationship. The optical engine module 100 according to this embodiment further includes an adjustment mechanism 160, such as an X-Y adjustment table arranged between the top plate 111 of the housing 110 and the component 131. The user adjusts a position of the component 131 of the positioning member 130 with respect to the top plate 111 of the housing 110 through the adjustment mechanism 160, and thus causes the optical element 120 to be moved, i.e. the user may thus achieve an effect of moving the optical element 120 and positioning the optical element 120 in the housing 110.

As mentioned above, the optical engine module 100 is provided with the components 131 and 132 corresponding to an upper contour and a lower contour of the optical element 120. Therefore, FIG. 5 and subsequent embodiments thereof are described only in terms of the structural features at the top plate 111. The component 132, the adjustment mechanism 160 (not shown) or other related components located at the bottom plate 113 are not repeated in the following because they have the same features.

Similarly, according to the embodiment shown in FIG. 6, the thermoelectric cooler 144 is arranged on the top plate 111 of the housing 110, and the heat exchanger 141 is in thermal contact with the thermoelectric cooler 144, and the heat generated by the prism 122 is also absorbed by the thermoelectric cooler 144 through the top plate 111 and the component 131 of the positioning member 130.

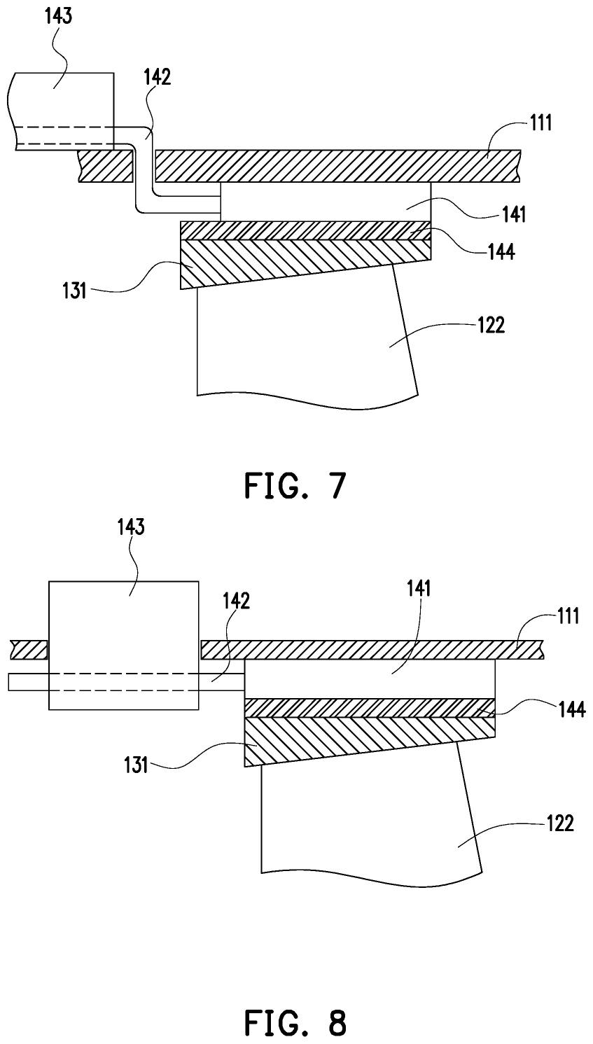

Next, referring to FIG. 7 and FIG. 8, for the convenience of describing the heat dissipation assembly 140, the adjustment mechanism 160 shown in FIG. 5 and FIG. 6 is omitted from FIG. 7 and FIG. 8. Referring to FIG. 7 first, the difference between FIG. 7 and the foregoing embodiment is that the heat exchanger 141 is disposed in the housing 110 (which is substantially located on an inner wall surface of the top plate 111) and is in thermal contact with the component 131 of the positioning member 130 through the thermoelectric cooler 144, and the heat pipe 142 extends from inside of the housing 110 through the top plate 111 of the housing 110 to outside of the housing 110. According to another embodiment not shown, the thermoelectric cooler 144 may also be removed so that the heat exchanger 141 is in direct structural contact with the component 131 of the positioning member 130.

Next, referring to FIG. 8, the difference between FIG. 8 and the foregoing embodiment is that the heat exchanger 141 and a portion of the heat pipe 142 of the heat dissipation assembly 140 according to this embodiment are both arranged in the housing 110, a portion of the heat sink 143 connected to the heat pipe 142 is located inside the housing 110, and the rest portion of the heat sink 143 is located outside of the housing 110.

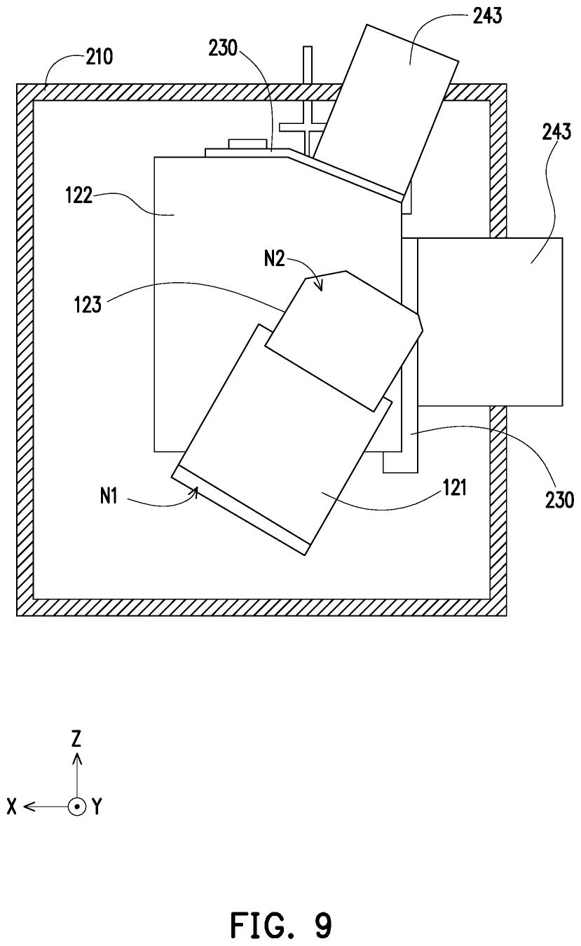

Next, referring to FIG. 9, unlike the foregoing embodiment, the positioning member according to this embodiment includes positioning members 230 disposed inside a housing 210 and located on different sides (two positioning members 230 on different sides are shown in FIG. 9). A heat dissipation assembly includes only two heat sinks 243 respectively disposed in the housing 210 and substantially in thermal contact with the two positioning members 230, while portions of the two heat sinks 243 extend out of the housing 210. In this way, in addition to absorbing heat generated by the prisms 121 to 123 through the positioning member 230, the heat sink 243 may transmit the heat to the housing 210 and dissipate the heat.

In summary, according to the embodiments of the disclosure, in the optical engine module and the projection device applying the optical engine module, the positioning member and the optical element are disposed in the housing, and then the heat dissipation assembly is coupled to the positioning member and absorbs the heat generated by the optical element through the positioning member, thereby transmitting the heat outside the housing. The heat dissipation means provides a heat dissipation path that transmits heat from the inside of the housing to the outside of the housing, which helps to improve the heat dissipation effect of the optical engine module and the projection device, and avoids contaminating the optical element or even causing damage to the optical element by providing cooling air flow directly to the element inside the housing.

The heat dissipation assembly of the optical engine module has corresponding configurations according to various requirements. One of the embodiments describes a heat exchanger of a heat dissipation assembly in thermal contact with a positioning member through a top plate of a housing, so that heat of an optical element is transmitted through the housing to the heat dissipation assembly. Another embodiment describes the presence of a thermoelectric cooler between the heat exchanger and the positioning member to facilitate heat exchange and transmission. Yet another embodiment describes that the heat exchanger and the heat pipe are both disposed inside the housing, and only a portion of the heat sink extends from the inside of the housing to the outside of the housing, which may also transmit the heat of the optical element out of the housing. In this way, the heat accumulated on the optical element of the optical engine module in the housing may be dissipated out of the housing according to the different methods.

The foregoing description of the preferred of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

What is claimed is:

1. An optical engine module for a projection device, wherein the optical engine module comprises:
a housing;
an optical element arranged in the housing;
a positioning member arranged in the housing and configured to abut and position the optical element; and
a heat dissipation assembly coupled to the positioning member, wherein the heat dissipation assembly absorbs heat generated by the optical element through the positioning member and transmits the heat outside the housing.

2. The optical engine module according to claim 1, wherein the heat dissipation assembly comprises a heat sink disposed outside the housing.

3. The optical engine module according to claim 2 further comprising a fan disposed outside the housing to generate air flow for heat dissipation of the heat sink.

4. The optical engine module according to claim 2, wherein the heat dissipation assembly further comprises a heat exchanger and a heat pipe, the heat exchanger is in thermal contact with the positioning member, and the heat pipe is connected between the heat exchanger and the heat sink.

5. The optical engine module according to claim 4, wherein the heat exchanger is disposed in the housing and contacts the positioning member, and the heat pipe extends from inside of the housing to outside of the housing.

6. The optical engine module according to claim 4, wherein the heat exchanger is disposed outside the housing to thermally contact the positioning member through the housing.

7. The optical engine module according to claim 4, wherein the heat exchanger, the heat pipe, and a portion of the heat sink are disposed in the housing, and the rest of the heat sink extends from inside of the housing to outside of the housing.

8. The optical engine module according to claim 4, wherein the heat dissipation assembly further comprises a thermoelectric cooler arranged between the positioning member and the heat exchanger.

9. The optical engine module according to claim 1, wherein the positioning member and the housing form an unitary structure.

10. The optical engine module according to claim 1 further comprising an adjustment mechanism arranged between the positioning member and the housing to adjust a position of the optical element in the housing.

11. The optical engine module according to claim 1, wherein contours of the positioning member and the optical element at a junction are adapted to each other and are complementary.

12. The optical engine module according to claim 1, wherein the optical element comprises at least two prisms, and adjacent parts of the at least two prisms are attached to each other by optical glue, such that relative positions of the at least two prisms are fixed.

13. A projection device comprising a light source, an optical engine module, a light valve, and a lens module, wherein the light source is configured to provide an illumination beam;
the optical engine module is configured to transmit the illumination beam to the light valve;
the light valve is configured to convert the illumination beam into an image beam;
the lens module is configured to project the image beam, and the optical engine module comprises:
a housing;
an optical element arranged in the housing, wherein the illumination beam passes through the optical element;
a positioning member arranged in the housing and configured to abut and position the optical element; and
a heat dissipation assembly coupled to the positioning member, wherein the heat dissipation assembly absorbs heat generated by the optical element through the positioning member and transmits the heat outside the housing.

14. The projection device according to claim 13, wherein the heat dissipation assembly comprises a heat sink disposed outside the housing.

15. The projection device according to claim 14 further comprising a fan disposed outside the housing to generate air flow for heat dissipation of the heat sink.

16. The projection device according to claim 14, wherein the heat dissipation assembly further comprises a heat exchanger and a heat pipe, the heat exchanger is in thermal contact with the positioning member, and the heat pipe is connected between the heat exchanger and the heat sink.

17. The projection device according to claim 16, wherein the heat exchanger is disposed in the housing and contacts the positioning member, and the heat pipe extends from inside of the housing to outside of the housing.

18. The projection device according to claim 16, wherein the heat exchanger is disposed outside the housing to thermally contact the positioning member through the housing.

19. The projection device according to claim 16, wherein the heat exchanger, the heat pipe, and a portion of the heat sink are disposed in the housing, and the rest of the heat sink extends from inside of the housing to outside of the housing.

20. The projection device according to claim 16, wherein the heat dissipation assembly further comprises a thermoelectric cooler arranged between the positioning member and the heat exchanger.

21. The projection device according to claim 13, wherein the positioning member and the housing form an unitary structure.

22. The projection device according to claim 13 further comprising an adjustment mechanism arranged between the positioning member and the housing to adjust a position of the optical element in the housing.

23. The projection device according to claim 13, wherein contours of the positioning member and the optical element at a junction are adapted to each other and are complementary.

24. The projection device according to claim 13, wherein the optical element comprises at least two prisms, and adjacent parts of the at least two prisms are attached to each other by optical glue, such that relative positions of the at least two prisms are fixed.
